(19) United States
(12) Patent Application Publication
(10) Pub. No.: US 2003/0124295 A1
(43) Pub. Date: Jul. 3, 2003

(54) Method for manufacturing an airbag cover

(76) Inventors: Wolfgang Gundlach, Bochum (DE); Udo Kansteiner, Witten (DE)

Correspondence Address: CHARLES K. VEENSTRA, DELPHI TECHNOLOGIES, INC., Legal Staff, Mail Code: 480-414-420, P.O. Box 5052, Troy, MI, 48007-5052, US

(21) Appl. No.: 10/241,366

(22) Filed: Sep. 11, 2002

(30) Foreign Application Priority Data
Oct. 5, 2001 (DE) 10149038.0

(51) Int. Cl. G09F 3/00

(52) U.S. Cl. 428/43; 428/137

(57) ABSTRACT

A method is provided for manufacturing an airbag cover, wherein at least one opening is formed in a carrier layer and foamed material is applied to the carrier layer while forming a recess.

### TECHNICAL FIELD

The invention relates to a method for manufacturing an airbag cover, to an airbag cover and to an apparatus for manufacturing an airbag cover as well as to an insert for a foaming tool.

### BACKGROUND OF THE INVENTION

Airbag systems are installed into motor vehicles as safety apparatuses in order to restrain the body, and in particular the head, of a vehicle occupant in the event of a violent collision of the motor vehicle and to thereby prevent serious injuries. Such an airbag system has as its main components the airbag, which inflates on a collision, a pyrotechnic gas generator, which is ignited on a collision and which delivers the gas required to inflate the airbag, a triggering sensory mechanism for igniting the gas generator and an airbag cover. The latter covers the airbag, which is folded together before a collision, and opens in the event of a triggering of the airbag as a consequence of the forces thereby occurring at one or more desired break points.

The airbag cover can be formed as a cover of the steering wheel hub, as a part of the instrument panel or as part of an inner door trim. The desired break points mostly consist of material weakenings, for example of linear perforations in the airbag cover which are not visible for the vehicle occupant and which are used for so-called hidden airbag doors.

Airbag covers are known which consist of an inner carrier layer and a foamed material layer which is arranged on the carrier layer and on which an outer cover layer visible in the vehicle passenger compartment is provided. The desired break points consist of hidden perforations which extend from the inner side of the carrier layer through the carrier layer and the foamed material layer up to just beneath the cover layer. Such perforations are mechanically introduced into the airbag cover from the inside, that is are stamped, cut or milled. The latter results in the disadvantage that the perforated parts have to be cleaned after milling. Stamping, cutting or milling produces open cells in the foam or foamed material at the surface of the perforation of the foamed material layer. When the airbag is triggered and the airbag cover opened, an unwanted formation of dust and foamed material particles can therefore occur.

### SUMMARY OF THE INVENTION

It is the object of the invention to provide a method for manufacturing an improved airbag cover and to provide an improved airbag cover and an apparatus for manufacturing the improved airbag cover.

This object is satisfied by the features of the independent claims.

Advantageous embodiments of the invention are described in the description, the drawing and the dependent claims.

The object is in particular satisfied in that at least one opening is formed at the position of the desired break point in the carrier layer and foam material is applied to the carrier layer while forming the foamed material layer and while forming a recess which extends from the rims of the opening into the foamed material layer.

In the method in accordance with the invention, the opening of the carrier layer can be formed during or after the shaping of the carrier layer. The recess arises in the region of the opening of the carrier layer and forms the desired break point with this. Since the recess in the foamed material layer is provided during the application of the foamed material to the carrier layer, a mechanical production of a perforation in the foamed material layer, e.g. by cutting, is not necessary. Moreover, since the foamed material hardens while forming the recess, substantially closed foamed material cells are formed at its surface. As a result of this, the production of dust and foamed material particles is avoided when the airbag cover is opened.

The foamed material can also be introduced into the opening. In this connection, the recess can be formed such that it extends through the opening into the foamed material layer from the side of the carrier layer which is arranged opposite the foamed cover layer. As a result of this, the rims of the opening are covered with foamed material, whereby damage to the airbag by the edges of the carrier layer is avoided when the airbag unfolds.

The recess can be formed such that it tapers from the rims of the opening into the foamed material layer. A desired break point which is invisible in the vehicle passenger compartment can thus be produced in a simple manner.

The recess can be formed while using a foaming tool which has a projection which projects through the opening during the formation of the recess and has a shape corresponding to the recess. The recess is thus formed during the hardening of the foam in contact with the projection. The foamed material cells at the surface of the recess are therefore closed. Moreover, the projection seals the opening of the carrier layer during the foaming procedure so that a foam leak through the opening into the foaming tool is avoided.

The foamed material can be introduced into an intermediate space between the carrier layer and a cover layer. A hidden desired break point can thus be produced which is located under a decorative cover layer.

The carrier layer can be formed integrated into a trim element. Due to the integrated formation of the carrier layer in a trim element, the number of components for the airbag system and thus the number of manufacturing steps is reduced.

The carrier layer can be provided with a reinforcement for the airbag. This reinforcement can, for example be a layer of a material, which is harder than the material of the cover layer, provided at the inner side of the carrier layer.

In accordance with a further aspect of the invention, the object is satisfied in that, in an airbag cover having a carrier layer, a foamed material layer arranged on the carrier layer and at least one desired break point, the carrier layer has at least one opening at the position of the desired break point and foamed material is provided at the carrier layer such that a recess extends from rims of the opening into the foamed material layer. The recess is therefore located in the region of the opening of the carrier layer and forms the desired break point with this.

The surface of the recess can substantially consist of closed foam cells. As a result of this, the production of dust and foamed material particles is avoided when the airbag cover is opened.

The foamed material can also be provided in the opening. For instance, a recess can be provided which extends from the side of the carrier layer which is arranged opposite the foamed material layer, through the opening into the foamed material layer. As a result of this, the rims of the opening are covered with foamed material, whereby damage to the airbag by the rims of the carrier layer is avoided when the airbag unfolds.

The recess can taper from the rims of the opening into the foamed material layer. If the recess extends, for example, up to the outer surface of the foamed material layer without penetrating the surface, a desired break point is formed in a simple manner which is invisible in the vehicle passenger compartment.

A cover layer can be provided at the side of the foamed material layer which is arranged opposite the carrier layer. The desired break point is thus covered by a decorative cover layer and invisible in the vehicle passenger compartment.

A cover layer which has a tear-open point at the position of the desired break point can be provided at the side of the foamed material layer which is arranged opposite the carrier layer. This facilitates the opening of the airbag cover when the airbag is triggered.

The carrier layer can be formed integrated in a trim element. Furthermore, the carrier layer can be provided with a reinforcement for the airbag. The reinforcement is, for example, a metal sheet which is injection molded into the trim element.

In accordance with a further aspect of the invention, the object is satisfied in that an apparatus for manufacturing an airbag cover, which comprises a carrier layer, a foamed material layer arranged on the carrier layer and at least one desired break point, with an opening being provided in the carrier layer at the position of the desired break point, is provided with a foaming tool for applying foamed material to the carrier layer, said tool comprising a means for forming a recess in the foamed material which extends from the rims of the opening into the foamed material layer. As a result of the means for forming the recess, the latter is formed during the hardening of the foam. The foamed material cells at the surface of the recess are therefore closed.

The foaming tool can be formed for introducing the foamed material into the opening. Moreover, the means for forming the recess can be made such that the recess extends from the side of the carrier layer which is arranged opposite the foamed material layer, through the opening into the foamed material layer. As a result of this, an airbag cover can be formed, in which the rims of the opening are covered with foamed material, whereby damage to the airbag by the edges of the carrier layer are avoided when the airbag unfolds.

The means for forming the recess can be formed such that the recess tapers from the rims of the opening into the foamed material layer. This makes it possible to form an airbag cover having a desired break point which is covered by the outer surface of the foamed material layer.

The means for forming the recess can be formed such that it fits through the opening of the carrier layer and has a shape corresponding to the recess. As a result of this, the means can seal the opening of the carrier layer during the foaming procedure so that, when the foamed material is applied, a foam leak through the opening in the foaming tool is avoided, with the means for forming the recess being a projection at the wall of the foaming tool.

Moreover, the means for forming the recess can be a projection of a TPE (tetraphenyl ethylene) insert for the foaming tool. A conventional foaming tool can therefore be easily converted to the production of the airbag cover in accordance with the invention. The TPE material results in the advantage that, for example when a PUR (polyurethane) foamed material is used, a sufficient separation of the materials takes place at the contact surface between the projection and the foamed material. Adhesion of the foamed material layer to the projection, which could be a disadvantage on the removal of the airbag cover, is thus avoided. Moreover, the formation of substantially closed foamed material cells is promoted by the separation of the materials at the surface of the recess.

The foaming tool can be desired for introducing the foamed material into an intermediate space between the carrier layer and a cover layer. A hidden desired break point which is located beneath a decorative cover layer can thus be produced with the foaming tool.

In accordance with a further aspect of the invention, the object is satisfied by an insert for a foaming tool which comprises a projection for forming a recess in the foamed material. A conventional foaming tool can thus be easily converted.

The insert can be made of TPE. If the insert is used in a method in which, for example, PUR (polyurethane) foam is processed, the TPE material has the effect of separating the projection from the foamed material. This supports the formation of closed foamed material cells at the surface of the recess. In addition, the removal of the product manufactured in the foaming tool is facilitated.

Moreover, the insert can be fixed to the foaming tool by means of a vacuum. A simple securing of the insert in the foaming tool is thereby realized.

The insert can comprise spacers for setting an intermediate space between the foaming tool and the insert and for fixing the insert to the foaming tool by means of a vacuum. It is ensured in this way that a vacuum is applied between the insert and the foaming tool which is sufficient for a uniform fixing of the insert.

The insert can be formed for manufacturing an airbag cover which comprises a carrier layer, a foamed material layer arranged on the carrier layer and at least one desired break point, with an opening being provided in the carrier layer at the position of the desired break point and with the projection being formed such that the recess extends from the rims of the opening into the foamed material layer. An airbag cover can thus be formed with the insert in which the rims of the opening are covered with foamed material, whereby damage to the airbag by the edges of the carrier layer are avoided when the airbag unfolds.

The projection can be designed such that the recess extends from the side of the carrier layer, which is arranged opposite the foamed material layer, through the opening into the foamed material layer. The projection can also be made such that the recess tapers from the rims of the opening into the foamed material layer. Furthermore, the projection can be made such that it fits through the opening of the carrier layer and has a shape corresponding to the recess. The advantages described above for the means for forming the recess are correspondingly realized by these embodiments of the projection.

### BRIEF DESCRIPTION OF THE DRAWINGS

The invention will be described purely by way of example in the following with reference to the attached drawings. There are shown:

FIG. 1 is, schematically, a cross-section through an embodiment of an apparatus in accordance with the invention for manufacturing an airbag cover having an airbag cover in accordance with the invention;

FIG. 2 is, schematically, a cross-section through a first embodiment of an airbag cover in accordance with the invention; and

FIG. 3 is, schematically, a cross-section through a second embodiment of an airbag cover in accordance with the invention.

### DESCRIPTION OF THE PREFERRED EMBODIMENTS

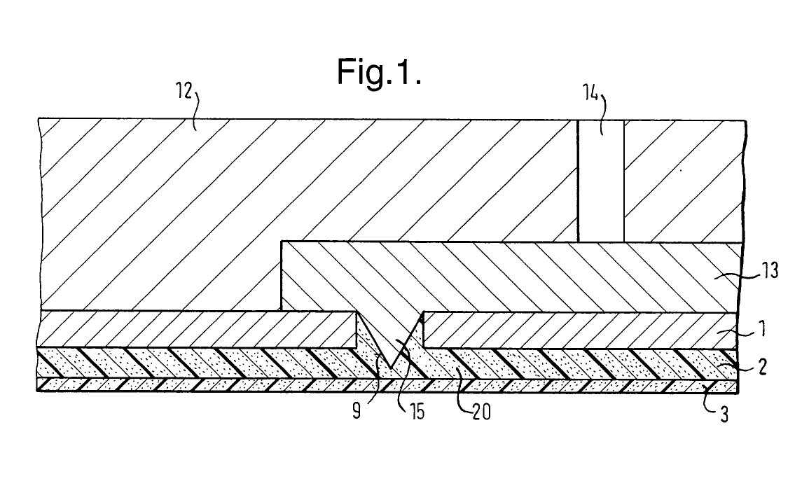

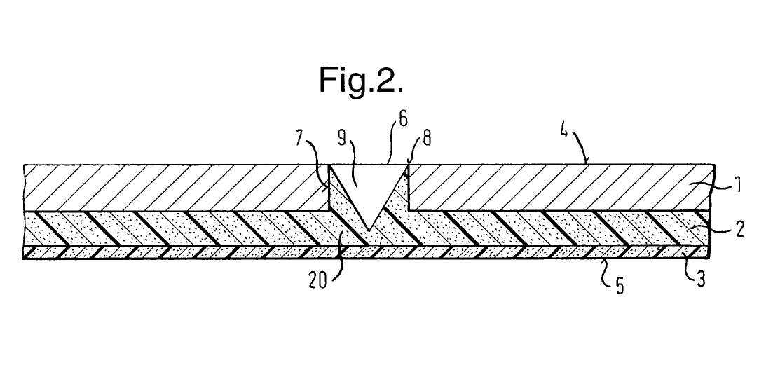

FIG. 1 shows an embodiment of an apparatus in accordance with the invention for manufacturing an airbag cover in a stage of the method in accordance with the invention in which the first embodiment of the airbag cover shown in FIG. 2 has already been produced, but has not yet been released from the apparatus.

The first embodiment of the airbag cover in accordance with the invention shown in FIG. 2 consists of a carrier layer 1, a foamed material layer 2 arranged thereon and a cover layer 3. The foamed material layer 2 and the cover layer 3 consist of polyurethane (PUR). The free sides of the cover layer 3 and of the carrier layer 1 form an inner side 4 or an outer side 5 of the airbag cover facing the vehicle passenger compartment. The carrier layer 1 includes at least one opening 6 whose rims 7 are completely covered with foamed material 20, i.e. PUR foamed material. The rims 7 form edges 8 with the inner side. A wedge-shaped recess 9 is provided in the foamed material 20 inside the opening 6 and in the foamed material layer 2. The recess 9 extends, starting from the edges 8, up to and into the foamed material layer 2 in which it ends just beneath the cover layer 3. The recess 9 is thus not visible from the outside. The opening 5 and the recess 8 result in a material weakening in the airbag cover which serves as the desired break point.

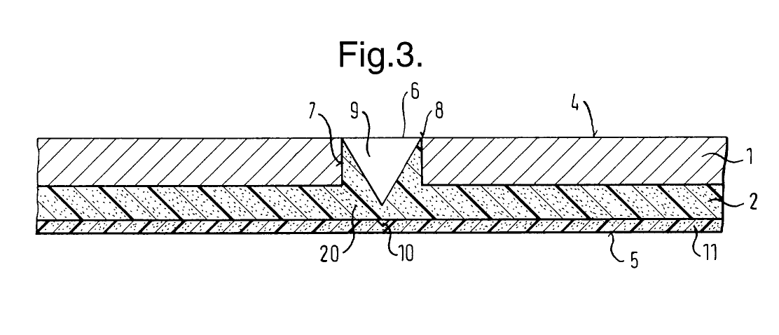

In the second embodiment of the airbag cover shown in FIG. 3, a cover layer 11, which additionally has a tear-open point 10 at the desired break point, is provided in place of the cover layer 3. The tear-open point 10 consists of a perforation of the cover layer 11 which is provided at the side of the cover layer 11 which faces the foamed material layer 2. The tear-open point is therefore likewise not visible from the outer side 5 and ensures a tearing open of the cover layer 11 at the desired break point and thus a problem-free opening of the airbag cover in the event of a vehicle collision.

An embodiment of the apparatus in accordance with the invention for manufacturing an airbag cover and the first embodiment of the airbag cover inserted therein are shown in FIG. 1. The embodiment of the apparatus consists of an upper part 12 of a foaming tool which can be set onto the carrier layer 1 in order to coat this with the foamed material layer 2. The upper part 12 is provided with a TPE (tetraphenyl ethylene) insert 13 which can be fixed to the upper part 12 via a passage 14 by means of a vacuum. The TPE insert 13 has a wedge-shaped projection 15 whose shape forms the recess 9.

In the method in accordance with the invention, the upper part 12, to which the TPE insert is fixed, is set onto the carrier layer 1 such that the projection 15 projects through the opening 6. The cover layer 3 made of PUR is secured to a lower part (not shown) of the foaming tool. The upper part 12 and the lower part are moved toward one another and an intermediate space is set between the carrier layer 1 and the cover layer 3 which corresponds to the desired thickness of the foamed material layer 2. Foamed material 20, i.e. PUR foamed material, is subsequently introduced into the intermediate space and thus also into the opening 6. The recess 9 is formed by hardening the foamed material made of PUR in contact with the projection 15 made of TPE. In this way, closed foam cells or foamed material cells arise at the surface of the recess 9. The projection 15 moreover prevents a foam leak from arising and foamed material from penetrating between the TPE insert 13 and the carrier layer 1.

In the method for manufacturing the second embodiment of the airbag cover, instead of the cover layer 3 a cover layer 11 is used which is provided with the tear-open point 10. The cover layer 11 is secured to the lower part such that the tear-open point 10 is oriented toward the carrier layer 1. To prevent foamed material from penetrating into the tear-open point 10 during the foaming procedure, the tear-open point 10 is previously covered with a sealing protective film (not shown).

1. A method for manufacturing an airbag cover comprising a carrier layer (1), a foamed material layer (2) arranged on the carrier layer (1) and at least one desired break point, characterized in that at least one opening (6) is formed at the position of the desired break point in the carrier layer (1); and in that foamed material (20) is applied to the carrier layer (1) while forming the foamed material layer (2) and while forming a recess (9) which extends from the rims (8) of the opening (6) into the foamed material layer (2).

2. A method in accordance with claim 1, characterized in that the foamed material (20) is introduced into the opening (6).

3. A method in accordance with claim 1, characterized in that the recess (9) is formed such that it extends from the side of the carrier layer (1) which is arranged opposite the foamed material layer (2), through the opening (6) into the foamed material layer (2).

4. A method in accordance with claim 1, characterized in that the recess (9) is formed such that it tapers from the rims (8) of the opening (6) into the foamed material layer (2).

5. A method in accordance with claim 1, characterized in that the recess (9) is formed while using a foaming tool (12; 12, 13) which has a projection (15) which projects through the opening (6) during the formation of the recess (9) and has a shape corresponding to the recess (9).

6. A method in accordance with claim 1, characterized in that the foamed material (20) is introduced into an intermediate space between the carrier layer (1) and a cover layer (3; 11).

7. A method in accordance with claim 1, characterized in that the carrier layer (1) is formed integrated into a trim element.

8. A method in accordance with claim 1, characterized in that the carrier layer (1) is provided with a reinforcement for the airbag.

9. A method in accordance with claim 1, characterized in that a foaming tool (12; 12, 13) is used and an insert (13), in particular a TPE insert (13), having a projection which projects through the opening (6) during the formation of the recess (9) and having a shape corresponding to the recess (9), is inserted into the foaming tool.

10. An airbag cover comprising
a carrier layer (1);
a foamed material layer (2) arranged on the carrier layer (1); and
at least one desired break point,
characterized in that the carrier layer (1) comprises at least one opening (6) at the position of the desired break point; and in that foamed material (20) is provided on the carrier layer (1) such that a recess extends from rims (8) of the opening (6) into the foamed material layer (2).

11. An airbag cover in accordance with claim 10, characterized in that the surface of the recess (9) substantially consists of closed foam cells.

12. An airbag cover in accordance with claim 10, characterized in that foamed material (20) is provided in the opening (6).

13. An airbag cover in accordance with claim 10, characterized in that the recess (9) extends from the side of the carrier layer (1) which is arranged opposite the foamed material layer (2), through the opening (6) into the foamed material layer (2).

14. An airbag cover in accordance with claim 10, characterized in that the recess (9) tapers from the rims (8) of the opening (6) into the foamed material layer (2).

15. An airbag cover in accordance with claim 10, characterized in that a cover layer (3) is provided at the side of the foamed material layer (2) which is arranged opposite the carrier layer (1).

16. An airbag cover in accordance with claim 10, characterized in that a cover layer (11), which has a tear-open point (10) at the position of the desired break point, is provided at the side of the foamed material layer (2) which is arranged opposite the carrier layer (1).

17. An airbag cover in accordance with claim 10, characterized in that the carrier layer (1) is formed integrated into a trim element.

18. An airbag cover in accordance with claim 10, characterized in that the carrier layer (1) is provided with a reinforcement for the airbag.

19. An apparatus for manufacturing an airbag cover which comprises a carrier layer (1), a molded material layer (2) arranged on the carrier layer (1) and at least one desired break point, wherein an opening (6) is provided at the position of the desired break point in the carrier layer (1), characterized by a foaming tool (12; 12, 13) for applying foam (20) onto the carrier layer (1), wherein the foaming tool (12; 12, 13) comprises a means (15) for forming a recess in the molded material (20) which extends from the rims (8) of the opening (6) into the foamed material layer (2).

20. An apparatus in accordance with claim 19, characterized in that the foaming tool (12; 12, 13) is formed for introducing the molded material (20) into the opening (6).

21. An apparatus in accordance with claim 19, characterized in that the means (15) for forming the recess is formed such that the recess (9) extends from the side of the carrier layer (1), which is arranged opposite the molded material layer (2), through the opening (6) into the molded material layer (2).

22. An apparatus in accordance with claim 19, characterized in that the means (15) for forming the recess is formed such that the recess (9) tapers from the rims of the opening (6) into the molded material layer (2).

23. An apparatus in accordance with claim 19, characterized in that the means (15) for forming the recess is formed such that it fits through the opening (6) of the carrier layer (1) and has a shape matching the recess (9).

24. An apparatus in accordance with claim 19, characterized in that the means (15) for forming the recess is a projection (15) at the wall of the foaming tool (12; 12, 13).

25. An apparatus in accordance with claim 19, characterized in that the means (15) for forming the recess is a projection (15) of a TPE insert (13) for the foaming tool (12; 12, 13).

26. An apparatus in accordance with claim 19, characterized in that the foaming tool (12; 12, 13) is formed for introducing the molded material (20) into an intermediate space between the carrier layer (1) and a cover layer (3; 11).

27. An insert for a foaming tool, characterized by a projection (15) for forming a recess in the molded material (20).

28. An insert in accordance with claim 27, characterized in that the insert (13) is made of TPE.

29. An insert in accordance with claim 27, characterized in that the insert (13) can be fixed to the foaming tool by means of a vacuum.

30. An insert in accordance with claim 27, characterized in that the insert (13) comprises spacers for setting an intermediate space between the foaming tool and the insert (13) and for fixing the insert (13) to the foaming tool by means of a vacuum.

31. An insert in accordance with claim 27 for manufacturing an airbag cover which comprises a carrier layer (1), a foamed material layer (2) arranged on the carrier layer (1) and at least one desired break point, wherein an opening (6) is provided at the position of the desired break point in the carrier layer (1), characterized in that the projection (15) is formed such that the recess extends from the rims (8) of the opening (6) into the foamed material layer (2).

32. An insert in accordance with claim 31, characterized in that the projection (15) is formed such that the recess (9) extends from the side of the carrier layer (1), which is arranged opposite the foamed material layer (2), through the opening (6) into the foamed material layer (2).

33. An insert in accordance with claim 31, characterized in that the projection (15) is formed such that the recess (9) tapers from the rims of the opening (6) into the foamed material layer (2).

34. An insert in accordance with claim 31, characterized in that the projection is formed such that it fits through the opening (6) of the carrier layer (1) and has a shape matching the recess (9).
